(19) United States
(12) Patent Application Publication
(10) Pub. No.: US 2005/0043911 A1
(43) Pub. Date: Feb. 24, 2005

(54) Method and device to test the operation safety of a process control device

(76) Inventors: Heinfried Hoffmann, Frankfurt am Main (DE); Thomas Karte, Lemgo (DE); Jorg Kiesbauer, Eppertshausen (DE); Ulrich Schulz, Offenbach am Main (DE); Karl-Bernd Schartner, Erlensee (DE)

Correspondence Address: SCHIFF HARDIN, LLP;PATENT DEPARTMENT, 6600 SEARS TOWER, CHICAGO, IL, 60606-6473, US

(21) Appl. No.: 10/840,114

(22) Filed: May 6, 2004

(30) Foreign Application Priority Data
May 6, 2003 (DE) 103 20 031.2-32

(51) Int. Cl. G06F 19/00

(52) U.S. Cl. 702/113

(57) ABSTRACT

A method and a device test the operating safety of a process control device with a control element and an actuator to move the control element, as well as a position controller in a safety circuit. A control unit is connected with the position controller and is coupled to the actuator such that the actuator can be operated to move the control element from an initial condition to a final condition in the event of an incident with the aid of a controlling of the actuator by the control unit. A measurement device acquires measurement signals indicating movement of the control element from the initial condition. The position controller comprises a control signal generator to generate a control signal for partial movement of the control element in a test cycle for the process control device, and to transmit the control signal via a signal connection from the position controller to the control unit.

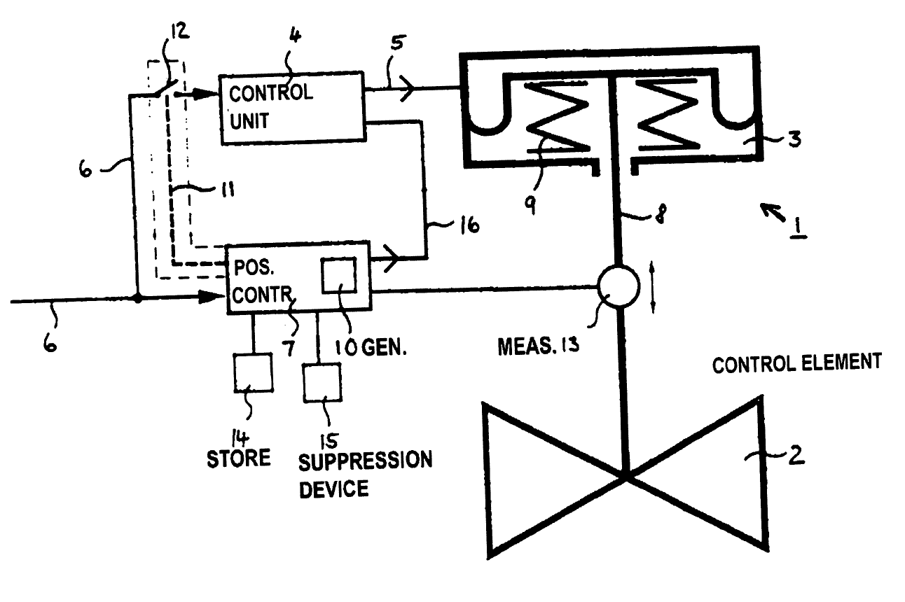

### BACKGROUND OF THE INVENTION

The invention is in the field of control and regulation technology for a process control device in a safety circuit.

In process systems, in addition to the devices to control and operate the system, components frequently exist whose object is to bring the process system to a safe operating state in the event of incident. In normal operation of the process system, these components normally have no function, i.e., they are not used over long periods of time.

Upon an incident, they serve to secure the process system by bringing it into a safe operating state. For example, this can be accomplished by, e.g., a complete closing or opening of critical conduits/pipelines, which means that, to close/open the critical conduits, the components are brought from an initial condition in which the critical conduits are completely open or completely closed into a final condition in which the critical conduits are then completely closed or completely opened. Components used for this are also designated as safety-relevant components. The component is normally a process control device which comprises a control element to intervene in the process in the process system, an actuator to move the control element, and a control unit (position controller, solenoid/magnetic valve combination or the like). The control element can, for example, be a process valve.

The frequently longer time span in which the process control device in the safety circuit is not operated makes it necessary to check the operational capability of the process control device in tests, so that it is assured that the process control device in the safety circuit can, in the event of incident, fulfill the intended protective function for the process system. From U.S. Pat. No. 6,186,167, a method is known in which a safety valve is moved in tests, whereby the test movement is activated by control signals that are generated by a digital or analog valve control. The generated control signals are sent to an actuator in order to operate the control element in tests.

From International Patent Publication WO 99/21066, an arrangement is known to test the operational capability of a safety device in a process system. To control the safety device, two solenoid valves are provided, whereby one solenoid valve serves to control the safety device in tests. The other solenoid valve is provided in order to control the safety device in the event of incident.

In the German Patent Publication DE 44 19 548, a method is described to monitor the provided operational capability of a control device, whereby a test signal that serves to test the provided operational capability and to identify the technical parameters (for example, friction) of the control device is superimposed on the real control signal at the output of a position controller.

### SUMMARY OF THE INVENTION

It is the object of the invention to provide a method and a device to test the operational capability of a safety-relevant process control device in a safety circuit, such that the probability of failure is reduced for the safety-relevant process control device in the event of incident.

This object is inventively achieved via a method to test operating safety of a process control device comprising a control element and an actuator to move the control element, a position controller in a safety circuit, the actuator being coupled to a control unit that is connected to the position controller for exchange of control signals, such that the actuator can be operated by way of the control unit to move the control element and the control element can be moved from an initial condition to a final condition in event of an incident by a control of the actuator by the control unit, a test cycle for the process control device comprising: generating a control signal for partial movement of the control element aided by the position controller; transferring the control signal from the position controller to the control unit via a signal connection; controlling the actuator dependent on the control signal aided by the control unit to operate the actuator for the partial movement of the control element from the initial condition; detecting, via a measurement device, measurement signals that indicate the partial movement of the control element from the initial condition; and returning the control element to the initial condition.

This object is also inventively achieved via a device to test the operating safety of a process control device, comprising: an control element; an actuator to move the control element; a position controller in a safety circuit; a control unit that is connected with the position controller configured to exchange control signals and is coupled to the actuator, such that the actuator can be operated via the control unit to move the control element in order to move the control element from an initial condition to a final condition in the event of incident with the aid of a controlling of the actuator by the control unit; a measurement device configured to acquire measurement signals that indicate a movement of the control element from the initial condition; the position controller comprising a control signal generator configured to generate a control signal for a partial movement of the control element in the course of a test cycle for the process control device, and to transmit the control signal via a signal connection from the position controller to the control unit.

In an arrangement in which the actuator of a process control device can be controlled to move the control element with a control unit and the control unit is coupled to the position controller, the invention comprises generating, with the aid of the position controller, a control signal to partially move the control element and to transmit the generated control signal to the control unit via a signal connection. Dependent on the control signal, the control unit then controls the actuator in order to partially move the control element from its initial condition. The partial movement of the control element is detected with the aid of a measurement device that can be part of the position controller. In this manner, a testing cycle is executed in which both the control unit and the actuator and the control element (including a piloting unit (for example, position controller)) are tested for operational capability, such that after a successful completion of the test cycle, it can be assumed that the reaction chain of the control unit via the actuator to the control element in the event of incident functions in the planned manner and brings the process system into a safe operating state.

The advantage achieved with the invention in comparison to the prior art is that all components of the safety circuit that must cooperate in the event of incident are included in the testing cycle. The test movement of the actuator to test the operational capability does not ensue via circumvention of individual components that are safety-relevant in the event of incident, which is, for example, the case when a control signal is indirectly passed for testing over the control unit to the actuator without activating the control unit (i.e., without intervention of) this control unit. A further advantage is that a separate control unit that is provided only to test the operational capability of the process control device can be saved.

An embodiment of the invention can provide that time-resolved path signals can be acquired with the aid of the measurement device upon detection of the measurement signals. The necessary movement of the actuator can hereby be tested in a simple manner in the test cycle.

For continuous analysis of the partial movement of the control element, it can be provided in a preferred embodiment of the invention that movement parameters are determined from the acquired time-resolved path signals. For example, speed or acceleration values or values for the path or characteristic times can hereby be determined. Furthermore, it can be provided that a time-path diagram can be created with the aid of the determined movement parameters.

The application possibilities of the method for various process systems are expanded in an appropriate embodiment of the invention, in that a leakage measurement is executed with the aid of the measurement device upon detection of the measurement signals.

The requirements (existing in connection with safety circuits) with regard to ensuring safety standards can be fulfilled in an embodiment of the invention, in that a curve of the test cycle is electronically logged (planned and configured) and electronically stored in a storage device. Electronic informations about the conducted test cycles are hereby available for a random monitoring. The storage device is preferably executed power-grid-independent, meaning it possesses an energy supply independent of the normal power grid, for example, a battery.

The user-friendliness in the application of the method is increased in an advantageous embodiment of the invention in which the test cycle for the process control device is activated with the aid of a remote control, for example, via a BUS system or HART.

An embodiment of the invention can appropriately provide that the actuator is a pneumatic actuator which is partially vented to partially move the actuator as a reaction to the control by the control unit. Pneumatic actuators are in particular suitable for environments with the risk of explosions in process systems.

An embodiment of the invention appropriately provides that the actuator is a hydraulic actuator which is partially hydraulically operated to partially move the actuator as a reaction to the control by the control unit. Hydraulic actuators can generate large forces. The hydraulic pump can be simply driven, for example, by way of a motor that is in turn supplied with electrical energy; a simple conversion of electrical energy into large forces is possible.

The features cited below regarding the device to test the operating safety of a process control device in a safety circuit correspondingly exhibit the advantages cited in connection with advantageous embodiments of the invention.

### DESCRIPTION OF THE DRAWINGS

The invention is explained in detail in the following using an exemplary embodiment and with reference to the FIGURE, which is a block schematic diagram of an embodiment of the invention.

### DETAILED DESCRIPTION OF THE PREFERRED EMBODIMENTS

The FIGURE is a schematic representation of an exemplary arrangement with a process control device 1 with a control element 2 and an actuator 3 to move the control element 2. The control element 2 is, for example, a process valve which is fashioned as part of a safety circuit in order to close/open a conduit in a process system in the event of incident.

A control unit 4 fashioned as a solenoid valve is coupled to the actuator 3 via a pneumatic connection 5. Connected to the control unit 4 is a signal line 6 that is furthermore connected to a position controller 7. A control signal is transmitted over the signal line 6 to the position controller 7 and the control unit 4. The control signal transferred via the signal line 6 indicates a normal operating state of the monitored process system, which (for example) occurs with the aid of a 24 volt level, thus, the control unit 4 controls the pneumatic auxiliary energy for the pneumatic actuator 3 such that the actuator 3 is provided with air. In contrast to this, when the control signal transferred via the signal line 6 indicates an incident (which corresponds in the selected example to the shortfall of the 24 volt level) the actuator 3 is controlled with the aid of the control unit 4 via the pneumatic output 5 such that the actuator 3 is vented/exhausted. The venting leads to the control element 2 (that is connected to the actuator 3 via a coupling element 8) being moved, which is the result of a movement of the coupling element 8 that is activated by a spring 9 in the actuator 3 upon venting of the actuator 3. In the event of an incident, the latter leads to the movement of the control element 2 into a final condition in order to bring the process system into a safe operating state in which, for example, a critical conduit is sealed off with the aid of the control element 2.

In order to test the operational capability of the arrangement according to the Figure, in the position controller 7, a test control signal is generated and transferred via a signal connection 11 to the control unit 4 with the aid of a generator 10 which, for example, can be a suitable logic component or module. The test control signal is generated in order to partially move the control element 2. Dependent on the received test control signal, via the pneumatic output 5, the control unit 4 controls the actuator 3 which is operated in this manner in order to partially move the control element 2. The signal transfer of the test control signal ensues in the embodiment shown in the FIGURE, in that the application of the control signal transferred via the signal line 6 to the control unit 4 and indicating the normal operating state is interrupted with the aid of a switch device 12. This control signal corresponds to an at least partial simulation of an incident.

The partial movement of the control element 2 is detected with the aid of a measurement device 13. The measurement device 13 can be, e.g., a movement sensor or a sound sensor. Depending on the type of sensor used, the detected measurement values can be, e.g., movement or sound measurement values. The measurement values can be electronically evaluated in order to automatically determine further information that characterize the movement of the control element 2. Starting from movement signals, for example, information can be determined about the time up to the beginning of the movement (breakaway), acceleration and/or speed in the movement of the control element 2. If, with the aid of the measurement device 13, a partial movement of the control element 2 is registered as a reaction to the transmission of the test control signal from the position controller 7 to the control unit 4, the operational capability of the arrangement has been tested with the control unit and the process control device 1. Information about one or more test cycles implemented in this manner as well as the measurement values hereby obtained can be stored in electronic form in a storage device 14. To ensure desired safety standards, the storage device 14 may be implemented independent of an energy supply of the position controller 7.

According to the FIGURE, a suppression device 15 is provided that can be operated by an operating personnel in order to prevent the generation (periodic or according to a statistical randomness) of the test control signal with the aid of the generator 10.

Via a signal connection 16 between the position controller 7 and the control unit 4, the actuator 3 can be controlled with the aid of the position controller 7 to move the control element 2 without hereby operating the control unit 4 (implemented in this exemplary embodiment as a solenoid valve).

The features of the invention disclosed in the preceding specification, the claims and the drawing can be of importance both individually and in arbitrary combination for the realization of the invention in its various embodiments. For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method to test operating safety of a process control device comprising a control element and an actuator to move the control element, a position controller in a safety circuit, the actuator being coupled to a control unit that is connected to the position controller for exchange of control signals, such that the actuator can be operated by way of the control unit to move the control element and the control element can be moved from an initial condition to a final condition in event of an incident by a control of the actuator by the control unit, a test cycle for the process control device comprising:
generating a control signal for partial movement of the control element aided by the position controller;
transferring the control signal from the position controller to the control unit via a signal connection;
controlling the actuator dependent on the control signal aided by the control unit to operate the actuator for the partial movement of the control element from the initial condition;
detecting, via a measurement device, measurement signals that indicate the partial movement of the control element from the initial condition; and
returning the control element to the initial condition.

2. The method according to claim 1, further comprising:
detecting time-resolved path signals upon detection of the measurement signals with the aid of the measurement device.

3. The method according to claim 2, further comprising:
determining movement parameters are determined from the detected time-resolved path signals.

4. The method according to claim 1, further comprising:
executing a leakage measurement upon detection of the measurement signals, aided by the measurement device.

5. The method according to claim 1, further comprising:
electronically logging of a course of the test cycle and electronically storing the course in a storage device.

6. The method according to claim 1, further comprising:
activating the test cycle for the process control device utilizing a remote control.

7. The method according to claim 1, further comprising:
partially venting the actuator, which is a pneumatic actuator, to partially move the control element as a reaction to the controlling by the control unit.

8. The method according to claim 1, further comprising:
partially hydraulically operating the actuator, which is a hydraulic actuator, to partially move the control element as a reaction to the controlling by the control unit.

9. A device to test the operating safety of a process control device, comprising:
a control element;
an actuator to move the control element;
a position controller in a safety circuit;
a control unit that is connected with the position controller configured to exchange control signals and is coupled to the actuator, such that the actuator can be operated via the control unit to move the control element in order to move the control element from an initial condition to a final condition in the event of incident with the aid of a controlling of the actuator by the control unit;
a measurement device configured to acquire measurement signals that indicate a movement of the control element from the initial condition;
the position controller comprising a control signal generator configured to generate a control signal for a partial movement of the control element in the course of a test cycle for the process control device, and to transmit the control signal via a signal connection from the position controller to the control unit.

10. The device according to claim 9, wherein the control unit and the position controller are redundantly coupled to the actuator to operate the actuator.

11. The device according to claim 9, wherein the actuator is a pneumatic actuator.

12. The device according to claim 9, wherein the actuator is a hydraulic actuator.

13. The device according to claim 9, wherein the measurement device comprises a motion sensor configured to detect the partial movement of the control element.

14. The device according to claim 9, wherein the measurement device comprises a sound sensor configured to detect the partial movement of the control element.

15. The device according to claim 9, further comprising:
a suppression device to suppress the generation of the control signal for the partial movement of the actuator in the course of the test cycle.

16. The device according to claim 9, further comprising:
a storage device configured to store electronic information concerning the test cycle.

17. The device according to claim 9, further comprising:
an evaluation device configured to automatically evaluate the measurement signals that indicate a movement of the control element from the initial condition.
